(19) United States
(12) Patent Application Publication
(10) Pub. No.: US 2012/0068967 A1
(43) Pub. Date: Mar. 22, 2012

(54) GLOVE AND TOUCHSCREEN USED TO READ INFORMATION BY TOUCH

(76) Inventors: Vincent Toubiana, Nozay (FR); Benoit Christophe, Nozay (FR); Vincent Verdot, Nozay (FR)

(21) Appl. No.: 13/265,099

(22) PCT Filed: May 6, 2010
(86) PCT No.: PCT/EP2010/056199

§ 371 Date: Nov. 28, 2011

(30) Foreign Application Priority Data
May 15, 2009 (FR) 0953217

(51) Int. Cl. G06F 3/045; A41D 19/00

(52) U.S. Cl. 345/174; 2/167

(57) ABSTRACT

This glove (G1) is used to read information by touch, whenever a finger (1) of this glove touches a screen (E1) comprising at least one area (31, 32, 33) emitting a continuous electrical field. This glove comprises at least one finger (1) comprising:
a flexible, dielectric internal wall (24) capable of accommodating a user's finger (28),
an external wall (23) that is flexible and dielectric,
a liquid (25) contained within at least one space between these two walls,
and microparticles (6, 7) placed inside this liquid, said microparticles being electrically charged with the same polarity, and being capable of moving within that liquid under the action of an electrical field.

The invention concerns a glove and touchscreen used to read information by touch, said glove transmitting, in tactile form, information provided to it by the screen, when a user puts on the glove and touches the surface of the screen with a finger of this glove.

Many mobile devices now comprise a touchscreen constituting a graphical interface for users: Users read icons or menus on this screen, and enter a command by touching, with a finger or a stylus, an area of the screen displaying an icon or a few words. To use a touchscreen, it is therefore necessary to see the screen in order to know where to touch the screen in order to enter a given command. However, in certain circumstances, the user cannot see what is displayed on the screen: for example if the device remains in the user's pocket or bag, or if the user is blind. In these circumstances, users cannot use a touchscreen since they cannot see the position of the sensitive areas of the screen, and cannot see the information displayed in response on the screen.

To assist the blind and the partially-sighted, it is known to use a text-speech conversion software, but this solution is not fully satisfactory. Such software is unable to describe anything other than text: for example an icon or a geometric shape cannot be directly converted into words. Furthermore, the reading of a displayed word does not indicate the position of said word on the screen. This solution does not therefore allow a command to be chosen on a touchscreen since the reading of a key word displayed does not indicate the area in which to touch the screen.

The aim of the invention is to resolve this disadvantage of touchscreens.

A first objective of the invention is a glove used to read information by touch, when a finger of said glove touches a screen containing at least one area emitting a continuous electrical field, which comprises at least one glove finger comprising:
a flexible, dielectric internal wall capable of accommodating a user's finger,
an external wall that is flexible and dielectric,
a liquid contained within at least one space between these two walls,
and microparticles placed inside this liquid, said microparticles being electrically charged with the same polarity, and being capable of moving within that liquid under the action of an electrical field.

The glove characterized in this way is used to perceive information by touch since it applies a variation in pressure to one of the user's fingers when the movement of the finger causes a variation of the electrical field applied to the charged microparticles. In fact, the variation of the electrical field applied to the charged microparticles causes a movement of these microparticles. This movement causes a variation in the pressure on the walls of the glove. This variation in pressure perceived by touching a screen allows a user to perceive graphics by touch.

A second objective of the invention is a touchscreen allowing information to be read by touch, comprising:
at least one electrode,
at least one voltage source,
and switching means connected to this electrode to create an electrical field from this electrode, said switching means being controlled by an information source;

in which said switching means are controlled so as to apply to this electrode a direct voltage which can take two opposing signs, its sign depending on binary information provided by the information source.

The screen characterized in this way allows binary information to be transcribed in a continuous electrical field, with a meaning depending on the value of this binary information, on an area of the screen. This screen therefore provides a sort of electrical image which can activate the glove according to the invention when the user is touching the surface of the screen with a finger.

A first application of this screen is the display of graphics for the blind, in particular Braille characters. A second application concerns people with normal eyesight, and who wish to be able to read information alternatively with their eyes and with their fingers. For this application, the screen comprises at least one transparent electrode, and it also comprises traditional means used to display an image, through this transparent electrode.

This screen can also be combined with traditional means used to enter commands by touching an area on the screen.

The invention will be better understood and other characteristics will appear with the help of the description below and the accompanying figures:

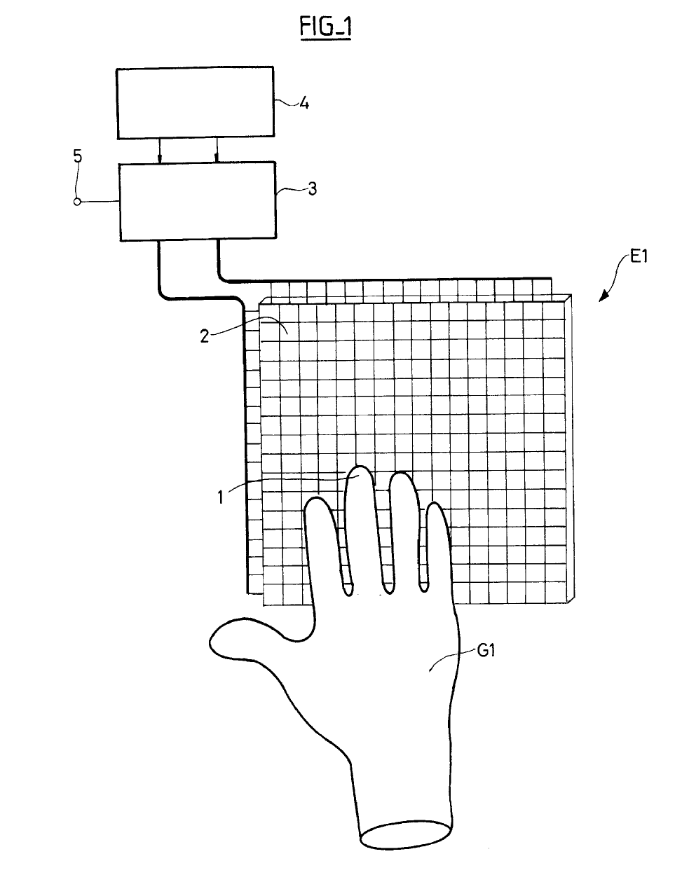

FIG. 1 shows a front view of a first embodiment of the glove according to the invention and a first embodiment of the screen according to the invention.

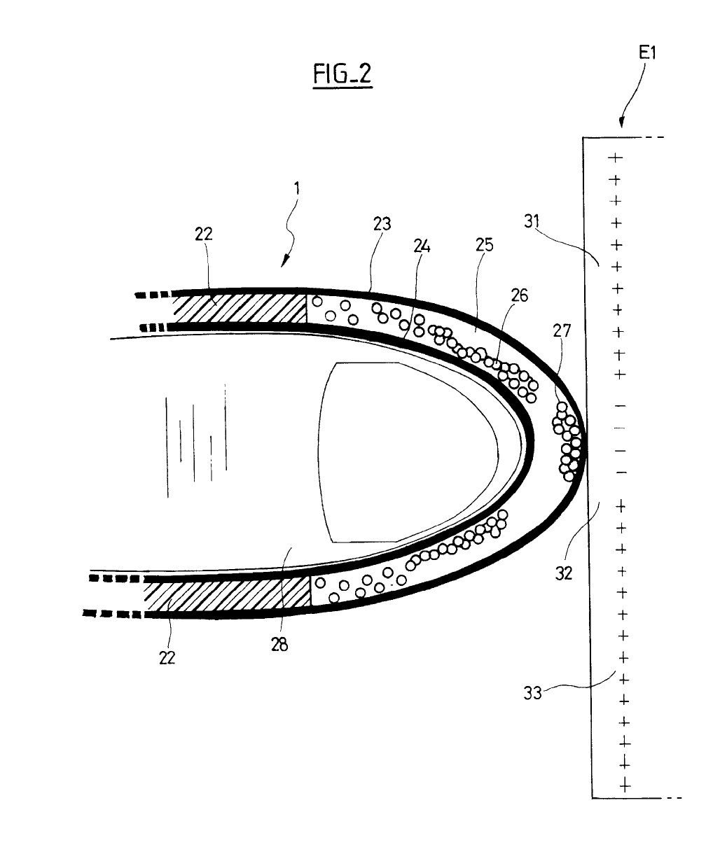

FIG. 2 shows a cross-section in diagram form of said first embodiment of the screen and a finger of said first embodiment of the glove according to the invention.

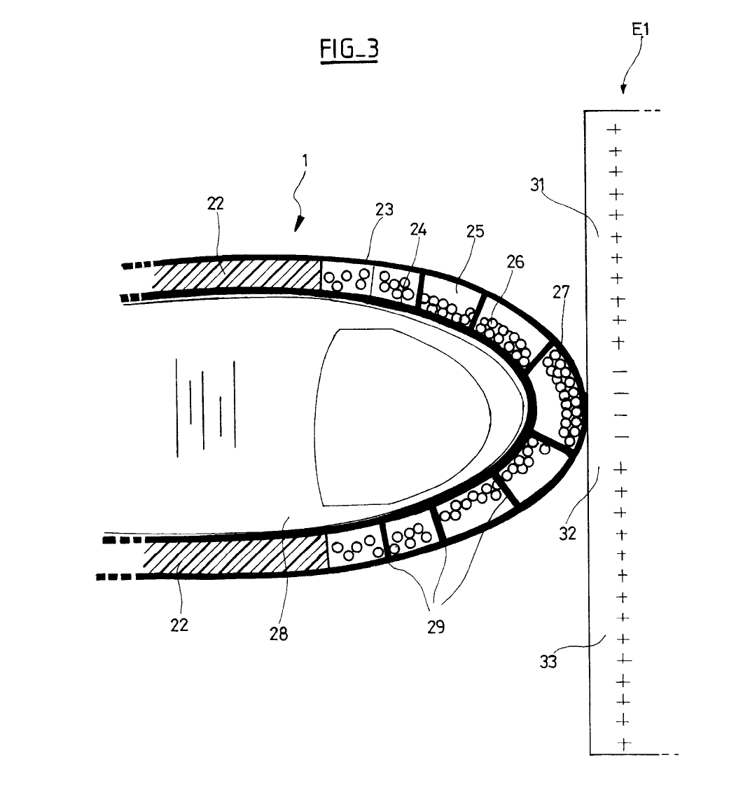

FIG. 3 shows a cross-section in diagram form of a finger of a second embodiment of the glove according to the invention.

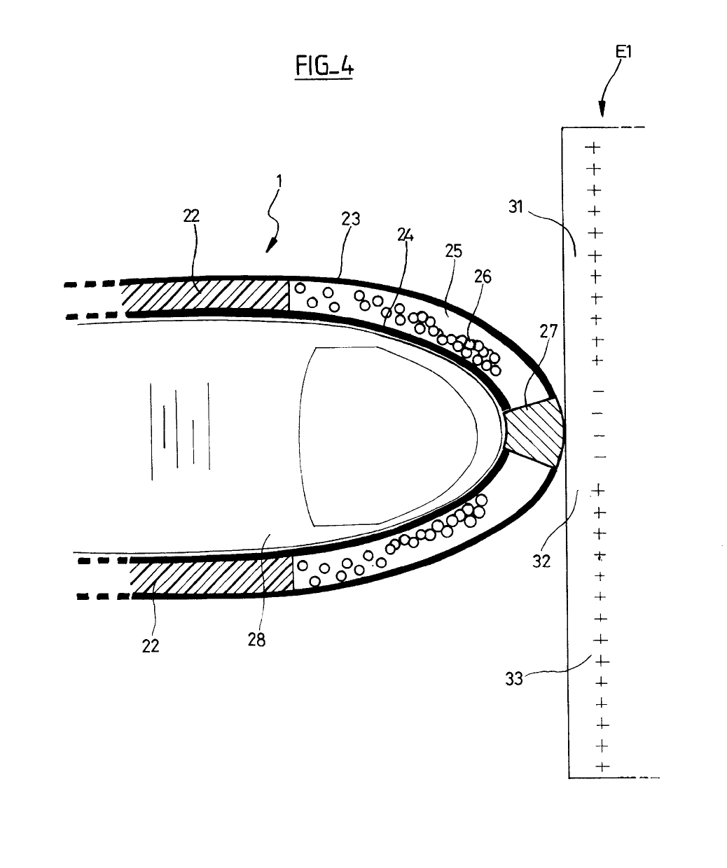

FIG. 4 shows a third embodiment of the screen according to the invention.

The elements which are identical in different embodiments are given the same references.

FIG. 1 shows a front view of this first embodiment G1 of the glove according to the invention and of this first embodiment E1 of the screen according to the invention. In this example, users touch one of the electrodes of the touchscreen E1 with a finger 1 of the glove G1.

The touchscreen E1 comprises:
a plurality of electrodes 2 arranged in the form of a matrix,
two voltage sources 4 to provide a positive voltage and a negative voltage, in relation to a reference potential,
and a switching circuit 3 connected to these two voltage sources 4, connected to these electrodes 2, and connected to a source of binary information 5.

For example, the surface of the screen E1 comprises a matrix of 16×16 electrodes 2 corresponding to 256 zones on the screen. A user can thus perceive, by touch, 256 different binary values, by touching the screen with a finger 1 of the glove G1.

The switching circuit 3 has an input connected to the source of binary information 5 to receive the information which should be perceived by touch. It is controlled so as to apply to a given electrode one of the two direct voltages provided by the sources 4. The sign of the voltage applied to an electrode 2 depends on a binary information item provided by the source of information 5 and corresponding to this electrode, in other words corresponding to a given area of the screen.

In this example, the source of binary information successively provides 256 binary values corresponding respectively to the 256 electrodes. The switching circuit 3 then provides the 256 voltages continuously, so long as there is not new information to be displayed.

FIG. 2 shows a cross-section of the glove finger, 1, of this first embodiment of the glove according to the invention, and a part of this first embodiment E1 of the touchscreen according to the invention. This glove finger 1 comprises:
A flexible internal wall 24 with elasticity and size adapted to adjust to a finger 28 of a user, such that the end of the glove finger 1 is perfectly in contact with the finger 28 of the user.
A flexible external wall 23 approximately parallel to the internal wall 24 so as to mark a space of a roughly constant thickness between the two walls 23-24.
A flexible material 22 fills this space along the largest part of the length of the glove finger 1, except at the end of the finger 1.
A dielectric liquid 25 fills the rest of this space, on the part located at the end of the finger 1.
Microparticles 26, 27 are free to move in this liquid 28. They are permanently electrically charged with the same polarity, for example positive.

The walls 23-24 are made of a dielectric material to send the electrical fields between the screen E1 and the finger 28 of the user. Furthermore, the walls 23-24 must be leakproof, at least in the area in contact with the liquid 25. For example, they may be made of rubber, polyethylene, polystyrene, nylon, vinyl, etc. The walls 23-24 must be fairly thin, for example a tenth of a millimeter, to allow good perception of the variations in pressure on the finger 28 of the user.

The microparticles 26-27 are for example titanium beads, with a diameter of around one micron. The dielectric liquid can be acetone, for example.

Other materials which are known for their use in electrophoretic display devices may be used. The document U.S. Pat. No. 6,262,833 describes microparticles and fluids which can be used in electrophoretic display devices. For the electrophoretic display devices, the microbeads are encapsulated in transparent microcapsules. However, to produce the glove according to the invention, there is no encapsulation of the microparticles before their introduction between the two walls 23-24.

The flexible filling material 22 may be neoprene, for example.

In the example shown, the electrodes of area 32 of the screen E1 receive a negative voltage, in relation to a reference potential, whereas the electrodes of areas 31 and 33 receive a positive voltage. The end of the glove finger 1 touches the surface of the screen E1 in area 32. Under the action of the electrical fields created by the electrodes of the screen E1, in areas 31, 32, 33, the microparticles 26-27, which are positively charged, undergo electrostatic forces which move them in the liquid 25: Microparticles 27 are drawn against the external wall 23 at the end of the glove finger 1 since this end is close to area 32 where the electrodes receive a negative voltage. Conversely, other microparticles 26, located opposite areas 31 and 32, are pushed back against the internal wall 24 and compress a part of the finger 28 of the user, this part taking approximately the form of a crown. As a result, users feel an increase in the pressure around the end of their finger 28 when it passes area 32. Users feel a reduction in pressure when their finger 28 moves out of area 32 to touch area 31 or area 33.

Each area used to display an icon or a menu option is preferably designed so as to coincide exactly with an electrode, or a whole number of electrodes, of the screen according to the invention, so that a user can accurately detect the position of this icon or this option using the glove according to the invention.

If the size of the screen and the number of electrodes is sufficient, it is possible to show a graphic which can be perceived with the glove according to the invention. In particular, it is possible to perceive a series of pulses similar to the relief constituting Braille characters.

FIG. 3 shows a cross-section in diagram form of a finger of a second embodiment of the glove according to the invention. It differs from the second example in the fact that the space, located between the walls 23-24 and containing the microparticles 26-27 comprises several walls 29 orthogonal to the external wall 23 and to the internal wall 24. They divide this space into compartments so as to reduce the movement of the microparticles in the direction parallel to the external wall and to the internal wall, while leaving them free to move either towards the internal wall 24 or towards the external wall 23, depending on the direction of the electrical field.

Furthermore, these walls 29 constitute spacers which maintain a roughly constant gap between the walls 23-24. They thus maintain a roughly even distribution of the microparticles in this space, all around the end of the finger 1.

In one embodiment, intended only for the blind, the screen only comprises electrodes intended to send information to a glove according to the invention.

In other embodiments, intended to be used alternatively with or without the glove according to the invention: the electrodes are transparent and are placed in front of a traditional display screen so as to allow a traditional display to be viewed, a liquid crystal display for example. In this case, the screen can be used alternatively to perceive information by sight or by touch.

This screen may also comprise means allowing it to be used as a traditional touchscreen, with or without the glove according to the invention, as long as the glove and these means for touch control are adapted to be able to work together. There are various existing technologies to produce touch control. Most of these technologies are compatible with the wearing of a glove, but not capacitive technology. This uses the existing capacity when the user's finger is very close to an electrode integrated into the screen. This technology does not generally work if the user is wearing a glove as the thickness of the glove means the tip of the finger is further away from the screen. A third embodiment according to the invention allows a touchscreen implementing capacitive technology to be used.

FIG. 4 shows a cross-section in diagram form of this third embodiment of the glove according to the invention. It differs from the second example in the fact that it comprises a conducting bridge 34, crossing the internal wall 24, the external wall 23, and the space between these two walls. It takes the form of a frustum of a cone. At one end, it touches the surface of the wall 23, at the tip of the finger 1, and at the other end it touches the surface of the internal wall 24. Therefore it is in contact with the finger 28 of the user and it is in contact with the surface of the screen E1 when the finger of glove 1 touches the screen E1. This conducting bridge has the effect of extending, from the electrical point of view, the end of the user's finger 28. This allows a touchscreen to be controlled using a capacitive effect and with insufficient sensitivity to operate when the finger 28 of the user is covered by a glove according to the invention to read information by touch.

This bridge 34 can be made of a flexible or rigid, conductive material, for example a carbon-loaded polymer.

The electrodes of the screen according to the invention may also constitute electrodes for the traditional tactile control function by capacitive effect. For example, these two functions may be alternately activated periodically.

Of course, the third embodiment may also comprise walls dividing the space containing the microparticles into compartments, as in the second example.

In other embodiments, the glove may comprise a plurality of glove fingers produced as described previously.

Conversely, a simplified variant of the glove according to the invention may only comprise one finger and nothing else, with the rest of the hand remaining uncovered.

1) Glove (G1) used to read information by touch, when a finger (1) of this glove touches a screen (E1) comprising at least one area (31, 32, 33) emitting a continuous electrical field, in which at least one finger (1) of the glove comprises:
a flexible, dielectric internal wall (24) capable of accommodating a user's finger (28),
an external wall (23) that is flexible and dielectric,
a liquid (25) contained within at least one space between these two walls,
and microparticles (26, 27) placed inside this liquid, said microparticles being electrically charged with the same polarity, and being capable of moving within that liquid under the action of an electrical field.

2) Glove according to claim 1, which also comprises walls (29) orthogonal to the external wall (23) and to the internal wall (24), and dividing the space marked by the external wall (23) and the internal wall (24) into compartments so as to reduce the movement of the microparticles in the direction parallel to the external wall (23) and the internal wall (24), leaving them free to move either towards the internal wall (24) or towards the external wall (23).

3) Glove according to claim 1, which also includes a conducting bridge (34) crossing the internal wall (24) and the external wall (23), at the end of a glove finger, so as to electrically extend the end of the finger (28) of a user of the glove.

4) Touchscreen (E1) used to read information by touch, comprising:
at least one electrode (2),
at least one voltage source (4),
and switching means (3) connected to this electrode (2) to create an electrical field from this electrode, said switching means being controlled by an information source (5);
in which said switching means (3) are controlled so as to apply to this electrode a direct voltage which can take two opposing signs, its sign depending on binary information provided by the information source (5).

5) Touchscreen according to claim 4, in which each electrode (2) is transparent,
and which also comprises traditional means used to display an image, through this transparent electrode.

6) Touchscreen according to claim 5, which also includes means used to enter a command by touching the screen.
